(19) United States
(12) Patent Application Publication
(10) Pub. No.: US 2016/0128348 A1
(43) Pub. Date: May 12, 2016

(54) LAYERED BEVERAGE

(71) Applicant: Kraft Foods R & D, Inc., Deerfield, IL (US)

(72) Inventors: Tulay Massey, Banbury (GB); Sarah Willaims, Banbury (GB); Simon Carr, Banbury (GB)

(21) Appl. No.: 14/742,613

(22) Filed: Jun. 17, 2015

(30) Foreign Application Priority Data
Nov. 7, 2014 (GB) 1419833.7

(51) Int. Cl. A23F 5/38

(52) U.S. Cl. CPC A23F 5/385

(57) ABSTRACT

A tablet for forming a beverage having two or more layers, the tablet comprising:
(i) a creamer/whitening component;
(ii) a flavouring; and
(iii) a biscuit component.

### CROSS-REFERENCE TO RELATED APPLICATION

This application claims priority to Great Britain Patent Application Number GB1419833.7 filed Nov. 7, 2014, the disclosure of which ishereby incorporated by reference in its entirety.

### FIELD

This disclosure relates to a tablet for forming a beverage. In particular, the tablet is for forming a beverage having two or more distinct layers when prepared by dissolution in hot/cold water in a single step.

### BACKGROUND

It is known to produce beverages with multiple layers. In particular, certain coffee shop beverages are provided with distinct layers of, for example, milk, coffee, chocolate or cream. These are prepared by trained staff and require considerable skill in pouring parts of the beverage without causing mixing of the layers.

When preparing such beverages at home, several cooking appliances are required, for example, to produce milk foam. Latte Macchiato type beverages with different layers are typically created using specially designed dispensing units that regulate flow rate (U.S. Pat. No. 06,799,613); or by using liquid concentrates with special dispensing machines (U.S.Pat. No. 7,013,933B2). In both cases, the separation between the layers relies specifically on the differences in density between the different liquids to create two or more layers. The processes are therefore limited by factors such as regulation of the flow rate and the order at which the liquid components are introduced. Beverages through either of these processes are achieved in more than one step and, therefore, maybe off-putting and complicated for the consumer.

It is also known for instant beverage formulations to mimic these beverages. For example, GB2452953 discloses a powdered composition having a milky layer, a coffee layer and a foam layer. A powder formulation would be expected to provide a homogeneous beverage when used in a single preparation step. However, GB2452953 provides three distinct layers on reconstitution with hot water, namely a top froth layer, a middle weak gel layer and a bottom liquid layer, respectively, from a loose powder mix. The middle layer is created as a result of the reaction of Carrageenan, with the main milk protein. The gel sits between the foam and the liquid interface creating the unique three-layered appearance. Presence of K+ and Ca2+ ions enhances the formation and strength of the gel for (κ-) and iota (ι-) carrageenans, respectively.

It is also known to produce two-layer beverages by using a pair of ingredients, such as a foaming creamer and a coffee ingredient with retarded solubility (DE19623296). In this way, clean foam is formed on the beverage medium, followed by the dissolution of the coffee component below.

It is also known to provide beverage ingredients in tablet form. Due to the typically poor dissolution of tablet ingredients, it is typically necessary to stir the dissolving mixture which would prevent any layered beverage formation.

### SUMMARY

Accordingly, it is desirable to provide an alternative method for readily preparing multiple layered beverages, in particular with the convenience of at-home preparation, and/or tackle at least some of the problems associated with the prior art or, at least, to provide a commercially useful alternative thereto.

According to a first aspect, the present disclosure provides a tablet for forming a beverage having two or more layers, the tablet comprising:
(i) a creamer/whitening component;
(ii) a flavouring; and
(iii) a biscuit component.

The present invention will now be further described. In the following passages different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

By tablet it is meant a composite body of ingredients suitable for forming, on dissolution, a beverage. Tablets are well known in the field of beverage preparation, including tablets of soluble coffee for an instant beverage, and tablets of roast and ground coffee for drip filters. Tablets are typically formed by compression and/or heating (sintering) and/or the inclusion of a binder. The tablet of the present invention is preferably formed by a combination of compression and heating.

The beverage formed from the tablet has two or more layers. That is, rather than forming a substantially homogeneous beverage, unless stirred, the ingredients will form into discrete layers. Typically, a foaming ingredient will form a foam on the surface of the beverage and the denser biscuit component will form a lower-most layer. It is noted that the layers are distinct in at least their appearance, preferably their appearance and/or flavour, but desirably also in their texture properties. Preferably the tablet forms three layers, one based on each of the foregoing (i)-(iii).

The term biscuit as used herein is intended to refer to a substantially dry bakery product, preferably a flour-based component. It will be appreciated that the biscuit may be provided as a single portion, or in the form of compressed crumbs or fragments from a biscuit-type ingredient. It is noted that suitable biscuits might also be referred to a cookies, wafers, crackers and the like.

The tablet comprises a creamer or whitening component (referred to herein as a creamer/whitening component). Creamers and whitening components are well known in the field of beverage preparation. Preferably the creamer/whitening component is a dairy or non-dairy creamer, and preferably is a foaming creamer. By foaming or effervescing, this component may more readily be drawn to the surface of the beverage. Suitable ingredients for forming foams on the surface of beverages are well known in the art. Preferably the creamer/whitening component comprises milk solids to provide an improved mouthfeel. It should be appreciated that the creamer/whitening component may comprise a mix of components including foaming ingredients and/or foam boosters, together with whitening ingredients such as milk solids.

The tablet comprises a flavouring. This may be included with the creamer/whitening component or the biscuit component, but is preferably included as a discrete portion of the tablet to thereby form its own layer in the beverage. Preferably the flavouring may include, but is not limited to, comprising soluble coffee, chocolate powder (or cocoa) or a flavouring selected from chocolate (or cocoa), vanilla, strawberry, cinnamon, mint, hazelnut, caramel, or a combination of two or more thereof. The flavouring may further comprise a colouring agent to make the distinction between the layers more obvious. Preferably the flavouring comprises soluble coffee and/or chocolate powder.

The tablet comprises a biscuit component. The biscuit component is in biscuit form before the beverage is prepared. Once it is contacted with a beverage medium, the dry texture of the biscuit will be altered. The biscuit is preferably semi-dissolvable. That is it will disperse in a beverage medium to form an edible/spoonable layer. Semi-dissolvable means that the biscuit will form a suspension in the beverage medium and does not dissolve per se, but disperses. Preferably the layer will have a consistency similar to cake, such as cake in a trifle. Alternatively, the biscuit component may retain a crunchy texture in at least portions when forming a suspended layer in a beverage.

Preferably the biscuit may be formed from crumbs, such as Oreo crumbs, digestive crumbs and the like.

Preferably the biscuit portion has an Aw of from 0.1 to 0.5, more preferably from 0.2 to 0.4 and most preferably about 0.3. The water activity (Aw) of a product is a notion which is well known in the food industry field. This value measures the availability of water in a sample. In most cases, this water activity is not proportional to the water content of the product. Methods for measuring Aw of a product are known to the person skilled in the art. For example, it can be measured with an Aqualab CX-2 or series 3, or a Novasina. All Aw values indicated hereafter are measured at 25±0.1° C.

Preferably the tablet has a mass of from 5 to 25 g, more preferably from 10 to 20 g, more preferably from 12 to 18 g. This provides a suitable strength of flavour while providing the consumer with a small and easily handled product for forming beverages.

Preferably the ratio by mass of creamer/whitening component to flavouring is from 1:1 to 5:1, more preferably the ratio is from 2:1 to 4:1. The creamer/whitening ingredient is typically required in a large amount to provide sufficient foam on the beverage. Preferably the ratio by mass of flavouring to biscuit is from 1:1 to 1:20, more preferably from 1:1.5 to 1:10 and most preferably from 1:1.5 to 1:2.5. The biscuit component is typically more bulky and is required in a larger amount to provide a consistent layer having a spoonable texture.

As a result of the three components, it is possible to form a two or three layer beverage. This has a foamed upper layer and a lower biscuit layer, optionally with a flavoured layer in between. The semi-dissolvable biscuit component provides the edible/spoonable bottom layer, whilst the creamer/whitener, such as a foaming dairy creamer component, provides the overall milk flavour and the creamy white foam.

Typically the layers form in the beverage as a result of the relative density. A foaming component may rise to the surface in view of trapped air, whereas the typically more dense biscuit layer may gravitate to the bottom of the beverage.

The relative solubility of one or more of the components may be controlled by different compaction and heating (RF) techniques in order to achieve the staggered dissolution and therefore more distinct colour/layer separation (e.g. white foam)

Preferably the tablet is formed by the method disclosed in GB 1311187.7 (GB251548.6). That is, preferably the tablet is formed from the various powdered ingredients, placed in a preheated mould and heated with RF above its tg, to thereby fuse the ingredients together homogeneously within the tablet.

According to a preferred embodiment, once made up, the beverage layers consist of a semi-dissolvable/dispersible and spoonable bottom layer with a cake/biscuit-like texture; a middle layer darker coffee (or other flavoured liquid); and a top milk/creamer layer with creamy white foam.

The tablet of the present invention provides a beverage with at least two distinct layers when prepared with hot/cold water in one step, eliminating the use of multiple sachets, containers or preparation devices with multiple components to provide a beverage with multiple layers.

This tablet offers an instant product formulation in a convenient format for the preparation of three layered beverages requiring no skill and no cooking appliances and eliminates the use of multiple sachets in order to make up multiple different components that can be separately made up and then mixed to create multiple layers on an instant beverage. On addition of water in one single simple step, a beverage with three distinct layers is formed. The use of a tablet as opposed to a loose powdered mix makes the preparation even easier and cleaner.

Preferably there is provided a tablet as described herein in a single-serving package. Such a packaging is preferably substantially air and/or water impermeable. Preferably the packaging is a sachet, preferably an at least partially transparent sachet to display the contents.

According to another aspect, there is provided a method of preparing a beverage, the method comprising adding a beverage medium to the tablet described herein.

According to another aspect, there is provided a beverage obtainable by dissolving the tablet in a beverage medium.

EP1201135 discloses a soluble black coffee which may include a flavouring. One of the many flavours mentioned here is a 0.1-1% biscuit aroma. These soluble flavours are used to impart the aroma of biscuits into the beverage to make it attractive. In contrast, however, the tablet disclosed herein contains actual biscuit crumbs compacted in the form of a tablet and then combined with other beverage ingredients including but not limited to soluble coffee, whitener and a foam booster to create a different format of a coffee/instant beverage. This advantageously can create distinct layers in which biscuit, liquid and the foam layers are clearly distinguishable and not only visually pleasing to the consumer but also provide different textural experiences during consumption.

WO2004095937 discloses powdered coffee and creamer compositions comprising chocolate confectionary particles having particles size of at least 1 mm. The main advantage is said to be that the presence of the confectionary particles and the creamer components give the consumer the impression of a more premium or a more attractive appearance before the beverage is made up. In use the chocolate/confectionary pieces melt upon addition of hot water and sink to the bottom due to their high density forming a bottom layer in the beverage.

In the tablet disclosed in the present disclosure, the ingredients are deliberately made into distinct layers within a tablet to provide a convenient form. These layers may then form in exactly the same order in the drink as they are in the tablet. Furthermore, the provision of a tablet allows the use of a creamer (and optionally a foam booster) which would normally be susceptible to any process that involves heat. The beverage tablet is compact, easy to carry, takes up less space than a sachet and each layer can be uniform and distinct providing a visually pleasing differentiation from mixed powders including bigger particles.

### BRIEF DESCRIPTION OF THE FIGURES

The invention will now be described in relation to the following non-limiting figures, in which:

FIG. 1 shows an exemplary layered tablet. The tablet has a layer of foaming creamer (1), a layer of instant coffee (2) and a layer of dispersible biscuit (3).

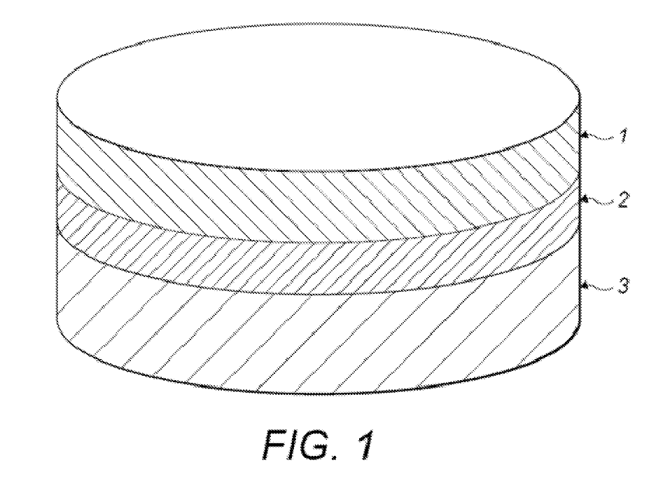

FIG. 2 shows an alternative embodiment in the form of a sphere with the layers arranged as encapsulating spheres and an example of a cup (5) of beverage formed by the aqueous reconstitution thereof. The tablet has a layer of foaming creamer (1), a layer of instant coffee (2) and a layer of dispersible biscuit (3). The dispersible biscuit forms a semi-dissolved biscuit layer (3a). The instant coffee (2) forms a milky coffee liquid layer (2a), including some of the foaming creamer (1). A portion of the foaming creamer (1) also forms a whiter foam layer (1a).

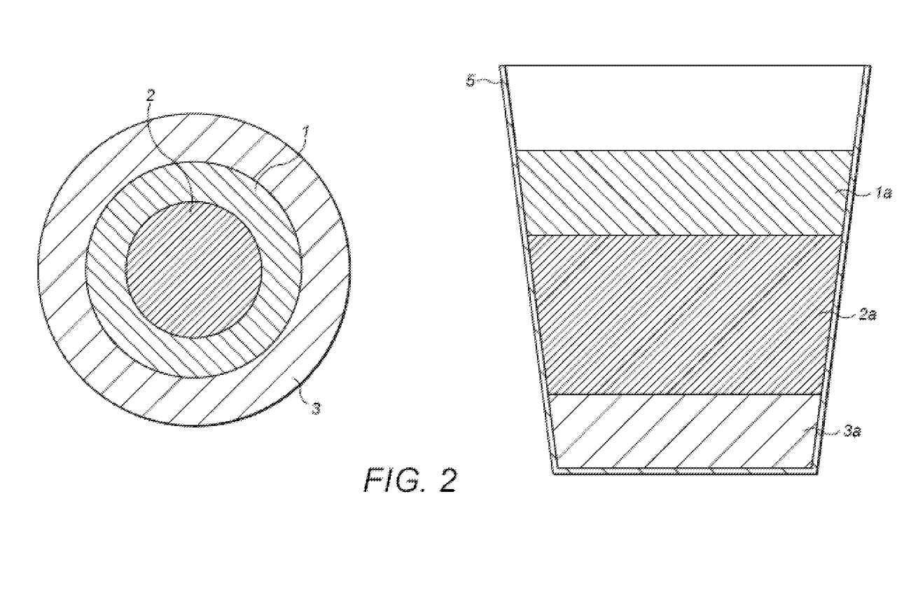

### DETAILED DESCRIPTION

The invention will now be described in relation to the following non-limiting examples.

### EXAMPLES

### Example 1

The following working example demonstrates the benefits of an instant cappuccino tablet dissolved with 100 ml hot (˜90° C.) water to form a three-layered beverage.

The tablet was made using conventional coffee mix ingredients comprising: 2 g of spray dried soluble coffee; 3.6 g of Oreo biscuit crumbs; 6 g of foaming creamer mix.

The foaming creamer mix comprised 2 g of foaming dairy creamer; 2 g of carbohydrate foam boosting agent (as described in EP1793686) and 2 g of sugar.

The tablet was formed in a mould made out of three parts, namely main body, ejector pin and the lid (the volume of the mould was approximately 32 cm3). The main part of the body and the ejector pin was heated using an RF oven to 96° C. and the lid was heated to ˜75° C. First the biscuit crumbs were added and levelled by light tapping. Then the coffee was added and levelled by light tapping. Finally the creamer, booster and sugar mix was added and levelled. The lid was then placed on top of the mould prior to compressing at 0.65 bar force using a compression tool for about 30 seconds. The mould was then left to rest for another 30 seconds. The tablet had distinct layers of biscuit, coffee and white creamer parts.

The tablet was dissolved using 100 ml of hot water (˜90° C.) whilst stirring gently for a few seconds. The resulting beverage had three distinct layers made out of a spoonable biscuit layer at the bottom, a middle layer of milky and sweet coffee and a creamy white layer of foam on top. The beverage had a good mouthfeel and sweetness and each layer could be easily distinguished through drinking.

### Example 2

The following working example demonstrates the benefits of an instant mocha tablet dissolved with 100 ml hot (˜90° C.) water to form a two-layered beverage.

The tablet was made using conventional coffee mix ingredients comprising: 2 g of spray dried soluble coffee; 3.6 g of Oreo biscuit crumbs; 6 g of dairy non-foaming creamer mix. The non-foaming creamer mix comprised 4 g of non-foaming dairy creamer and 2 g of sugar.

The said tablet was formed in the mould made out of three parts. The main part of the body and the ejector pin was heated using RF oven (details) to 96° C. and the lid was heated to 75° C. First the creamer was added and levelled by light tapping. Then the coffee was added and levelled by light tapping. Finally the creamer and sugar mix was added and levelled. The lid was then placed on top of the mould prior to compressing at 0.65 bar force for about 30 seconds. The mould was then left to rest for another 30 seconds. The tablet had distinct layers of biscuit, coffee and white creamer parts.

The tablet was dissolved using 100 ml of hot water (˜90° C.) whilst stirring gently for a few seconds. The resulting beverage had two distinct layers made out of a spoonable biscuit layer at the bottom and a top layer of milky and sweet coffee on top. The beverage had a good mouthfeel and sweetness and each layer could be easily distinguished through drinking

Although preferred embodiments of the invention have been described herein in detail, it will be understood by those skilled in the art that variations may be made thereto without departing from the scope of the invention or of the appended claims.

1. A tablet for forming a beverage having two or more layers, the tablet comprising:
(i) a creamer/whitening component;
(ii) a flavouring; and
(iii) a biscuit component.

2. A tablet according to claim 1, for forming a beverage having three layers.

3. A tablet according to claim 1, wherein the creamer/whitening component is a dairy or non-dairy creamer, and preferably is a foaming creamer.

4. A tablet according to claim 1, wherein the creamer/whitening component comprises milk solids.

5. A tablet according to claim 1, wherein the tablet has a mass of from 5 to 25 g, preferably 10 to 20 g.

6. A tablet according to claim 1, wherein the components (i) to (iii) are provided in substantially discrete portions of the tablet, preferably in substantially discrete layers of the tablet.

7. A tablet according to claim 1, wherein the flavouring comprises soluble coffee, chocolate powder or a flavouring selected from chocolate, vanilla, strawberry, cinnamon, mint, hazelnut, caramel, or a combination of two or more thereof, preferably soluble coffee and/or chocolate powder.

8. A tablet according to claim 1, wherein the biscuit component has an Aw of from 0.1 to 0.5.

9. A tablet according to claim 1, wherein the ratio by mass of creamer/whitening component to flavouring is from 1:1 to 5:1 and/or wherein the ratio by mass of flavouring to biscuit component is from 1:1 to 1:20.

10. A tablet according to claim 9, wherein the ratio by mass of creamer/whitening component to flavouring is from 2:1 to 4:1 and/or wherein the ratio by mass of flavouring to biscuit component is from 1:1.5 to 1:2.5.

11. A tablet according to claim 1 in a single-serving package.

12. A method of preparing a beverage, the method comprising adding a beverage medium to the tablet of claim 1.

13. A beverage obtainable by dissolving the tablet according to claim 1 in a beverage medium.
